(19) United States
(12) Patent Application Publication
(10) Pub. No.: US 2024/0367586 A1
(43) Pub. Date: Nov. 7, 2024

(54) VEHICULAR MIRROR REFLECTIVE ELEMENT WITH PHOTOCHROMIC LAYER

(71) Applicant: Magna Mirrors of America, Inc., Holland, MI (US)

(72) Inventors: Alexander J. Reau, Wyoming, MI (US); Anthony J. Schutz, Warren, MI (US)

(21) Appl. No.: 18/650,156

(22) Filed: Apr. 30, 2024

Related U.S. Application Data
(60) Provisional application No. 63/499,313, filed on May 1, 2023.

(51) Int. Cl. B60R 1/08; B60R 1/06; G02F 1/153

(52) U.S. Cl. CPC B60R 1/088; B60R 1/06; G02F 1/1533; G02F 2202/14; G02F 2203/02

(57) ABSTRACT

A vehicular mirror reflective element includes at least one glass substrate that has a first side that is closest to and viewed by a driver of a vehicle equipped with a vehicular rearview mirror assembly that includes the vehicular mirror reflective element. A mirror reflector is disposed at another side of the at least one glass substrate that is different than the first side. A photochromic layer is disposed at the first side of the at least one glass substrate of the vehicular mirror reflective element.

### CROSS REFERENCE TO RELATED APPLICATION

The present application claims the filing benefits of U.S. provisional application Ser. No. 63/499,313, filed May 1, 2023, which is hereby incorporated herein by reference in its entirety.

### FIELD OF THE INVENTION

The present invention relates generally to the field of rearview mirror assemblies for vehicles.

### BACKGROUND OF THE INVENTION

It is known to provide a mirror assembly that has an electrochromic mirror reflective element that dims when glare light is detected during nighttime or low ambient lighting conditions.

### SUMMARY OF THE INVENTION

A vehicular rearview mirror assembly includes a mirror reflective element, which includes at least one glass substrate and a mirror reflector disposed at a side of the at least one glass substrate. The at least one glass substrate has a first side that is closest to and viewed by a driver of the vehicle when the mirror assembly is mounted at a vehicle. A photochromic coating or layer is disposed at the first side of the at least one glass substrate of the mirror reflective element. The layer of photochromic material provides for mirror dimming or coloring during daytime driving conditions to reduce sun glare (upon UV exposure or photo-irradiation of the layer). When not exposed to sunlight, the layer of photochromic material is transparent and thus does not affect electrochromic performance during nighttime driving conditions. The rearview mirror assembly may comprise an exterior rearview mirror assembly configured for mounting at a side of the vehicle.

These and other objects, advantages, purposes and features of the present invention will become apparent upon review of the following specification in conjunction with the drawings.

### BRIEF DESCRIPTION OF THE DRAWINGS

FIG. 1 is a view of an exterior rearview mirror assembly;

FIG. 2 is a sectional view of an electrochromic mirror reflective element having a photochromic layer or film or coating disposed at a front or first surface of the front glass substrate, showing the photochromic layer as untinted in the absence of UV light;

FIG. 3 is a sectional view of the electrochromic mirror reflective element of FIG. 2, showing the photochromic layer as tinted in the presence of UV light;

FIG. 4 is a graph showing the absorbance of the film versus time with and without exposure to UV irradiation;

FIG. 5 shows images of a mirror with a 1 mm thick photochromic layer of 1% Naphthopyran and a mirror without the photochromic layer, when both are exposed to daylight; and

FIG. 6 shows images of a mirror with a 0.25 mm thick photochromic layer of 0.11% Naphthopyran when exposed to differing levels of daylight.

### DESCRIPTION OF THE PREFERRED EMBODIMENTS

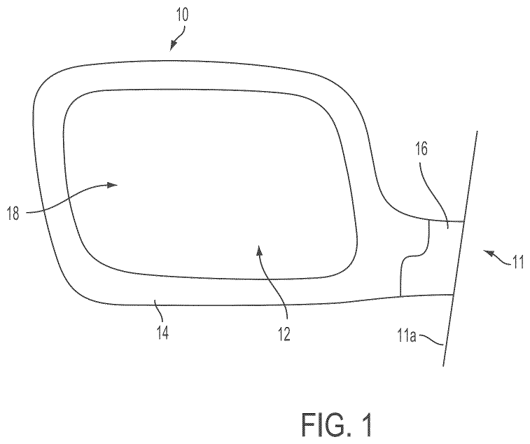

Referring now to the drawings and the illustrative embodiments depicted therein, an exterior rearview mirror assembly 10 for a vehicle 11 includes a mirror reflective element 12 received in and/or supported at or by a mirror shell or casing or mirror head 14 (FIG. 1). The mirror head 14 may be fixedly attached at a mounting arm or base 16 at the side of the vehicle or may be movably mounted to a mounting arm or base or portion 16, and may comprise a breakaway mirror (where the mirror head portion may be manually pivoted about the mounting arm or base) or may comprise a powerfold mirror (where the mirror head portion may be pivoted via an actuator assembly or adjustment device). The mounting arm or base 16 of the mirror assembly 10 is mounted at a side 11a of a host or subject vehicle 11, with the mirror reflective element 12 providing a rearward field of view along the respective side of the vehicle 11 to a driver of the vehicle, as discussed below.

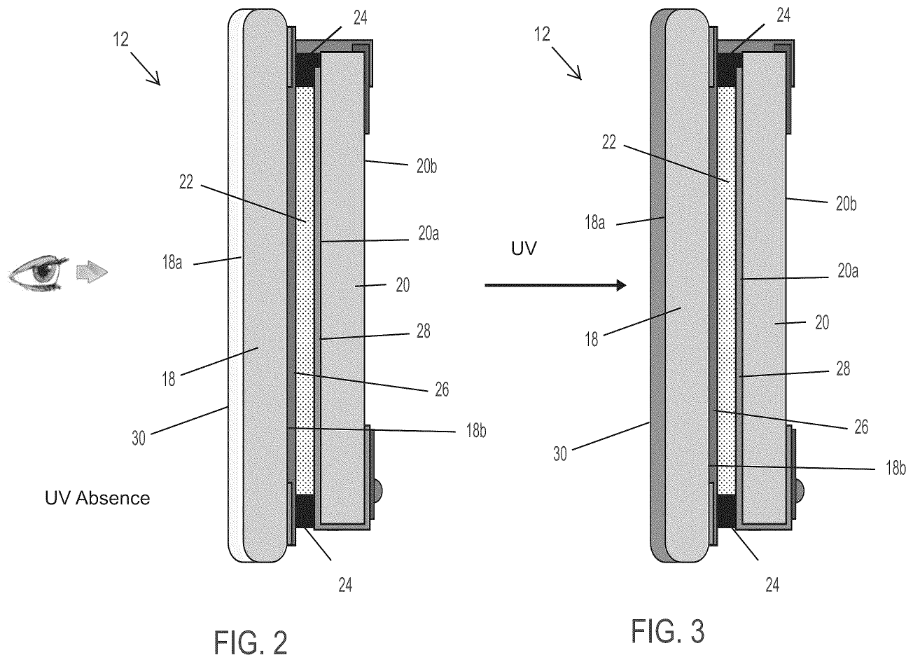

In the illustrated embodiment, and as shown in FIGS. 2 and 3, the mirror reflective element 12 comprises a laminate construction variable reflectance electro-optic (such as electrochromic) reflective element assembly having a front substrate 18 and a rear substrate 20 with an electro-optic medium 22 (such as electrochromic medium) sandwiched therebetween and bounded by a perimeter seal 24. As shown in FIGS. 2 and 3, the front substrate 18 has a front or first surface 18a (the surface that generally faces the driver of a vehicle when the mirror assembly is normally mounted at the vehicle) and a rear or second surface 18b opposite the front surface 18a. The rear substrate 20 has a front or third surface 20a and a rear or fourth surface 20b opposite the third surface 20a, with the electro-optic medium 22 disposed between the second surface 18b and the third surface 20a and bounded by the perimeter seal 24 of the reflective element (such as is known in the electrochromic mirror art). The second surface 18b of the front glass substrate 18 has a transparent conductive coating 26 established thereat (such as an indium tin oxide (ITO) layer, or a doped tin oxide layer or any other transparent electrically semi-conductive layer or coating or the like (such as indium cerium oxide (ICO), indium tungsten oxide (IWO), or indium oxide (IO) layers or the like or a zinc oxide layer or coating, or a zinc oxide coating or the like doped with aluminum or other metallic materials, such as silver or gold or the like, or other oxides doped with a suitable metallic material or the like), or such as disclosed in U.S. Pat. No. 7,274,501, which is hereby incorporated herein by reference in its entirety), while the third surface 20a of the rear glass substrate 20 has a metallic reflector coating 28 (or multiple layers or coatings) established thereat. The front or third surface 20a of the rear substrate 20 may include one or more transparent semi-conductive layers (such as an ITO layer or the like), and one or more metallic electrically conductive layers (such as a layer of silver, aluminum, chromium or the like or an alloy thereof), and may include multiple layers such as disclosed in U.S. Pat. Nos. 7,274,501; 7,184,190 and/or 7,255,451, which are hereby incorporated herein by reference in their entireties. The mirror reflector may comprise any suitable coatings or layers, such as a transflective coating or layer, such as described in U.S. Pat. Nos. 7,626,749; 7,274,501; 7,255,451; 7,195,381; 7,184,190; 6,690,268; 5,140,455; 5,151,816; 6,178,034; 6,154,306; 6,002,511; 5,567,360; 5,525,264; 5,610,756; 5,406,414; 5,253,109; 5,076,673; 5,073,012; 5,115,346; 5,724,187; 5,668,663; 5,910,854; 5,142,407 and/or 4,712,879, which are hereby incorporated herein by reference in their entireties, disposed at the front surface of the rear substrate (commonly referred to as the third surface of the reflective element) and opposing the electro-optic medium, such as an electrochromic medium disposed between the front and rear substrates and bounded by the perimeter seal (but optionally, the mirror reflector could be disposed at the rear surface of the rear substrate (commonly referred to as the fourth surface of the reflective element)).

The third surface 20a defines the active EC area or surface of the rear substrate within the perimeter seal 24. The coated third surface 20a may also be coated to define a tab-out region (such as by utilizing aspects of the mirror assemblies described in U.S. Pat. Nos. 7,274,501; 7,184,190 and/or 7,255,451, which are hereby incorporated herein by reference in their entireties) for providing electrical connection of the conductive layers to an electrical clip of connector or bus-bar, such as the types described in U.S. Pat. Nos. 5,066,112 and 6,449,082, which are hereby incorporated herein by reference in their entireties.

When a vehicle is driven in the morning or evening, there can be sun glare at the mirror reflective element that is bothersome to the driver of the vehicle. The mirror reflective element 12 includes a photochromic coating 30 (e.g., a thin-film coating of a photochromic material or solution) at the first or front side or surface of the reflective element that darkens when exposed to sunlight (ultraviolet radiation) and the degree of darkening or coloring depends on the intensity of the sunlight to which it is exposed. The photochromic coating or layer may be applied to or coated on the first or front or outermost surface of the mirror reflective element (i.e., the surface of the mirror reflective element that is exposed to sunlight). This improves the driver's view by reducing glare from the sun (such glare may occur when the vehicle is heading in a westward direction in the morning or in an eastward direction in the evening). The photochromic coating or layer provides for dimming or coloring during daytime operation, while electrochromic dimming may be provided during nighttime operation.

Functional groups of molecules have specific wavelengths of light that will be absorptive, causing the molecule to appear a visible color of 380-750 nm wavelength. In a chromophoric transitional molecule, the application of energy in various forms can change the molecule's color. The types of energy input include pressure (Piezochromic), temperature (Thermochromic), EM waves (Photochromic), electrical current (Electrochromic), etc.

Applied current provides electron for chromophore conversion, resulting in an EC cell. With an electrochromic cell, application of electrical current allows for electron to be donated to the viologen molecule:

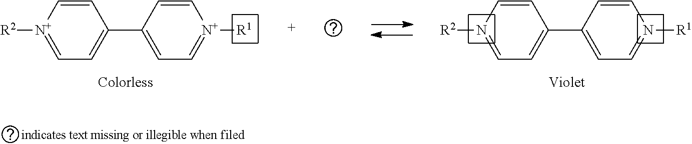

Varying functional groups on “R1 or R2” will result in various color schemes and can even be “tuned in” to provide appropriate coloring effects, or to provide alternate properties for better functionality. For example, the color may be selected to provide enhanced performance in reducing glare and/or may be selected based on customer (e.g., the mirror manufacturer or the vehicle manufacturer) preference.

Upon the introduction of outside energy input, such as electromagnetic waves, a photochromic dye will undergo a change in the bond structure of a molecule, resulting in an alteration of the functional group. This alteration will make the current color of the molecule change. The standard version of this is via the introduction of UV-light, causing the break in the oxygen bond, resulting in a color change. Changes in the functional groups R1, R2, etc. will change the properties of the pyran molecule, resulting in differences in coloration, coloration time, time to reversion, cyclability etc.

The photochromic molecule is a molecule that will change color when a light source shines on it. In most instances, UV light will be utilized due to its high intensity and controllable wavelength. The pyran functional group on a molecule will result in a color shift from colorless to yellow:

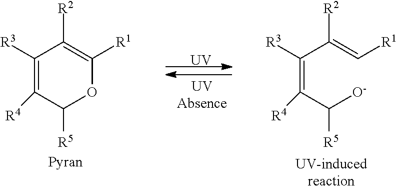

The breaking of the Oxygen-Carbon bond and resulting molecule causes the color shift. When combined with further functional groups in the R* positions, the molecule will become more stable, decrease time to color, and eventually allow for varying color systems, the most common of which would be Naphthopyran:

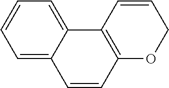 [SMILES: C1=Cc2c(ccc3ccccc23)OC1]

This molecule can be incorporated into polymer systems to provide a thin-film coating (TFC) which will change color upon introduction or exposure to UV light (photo-irradiation). A TFC containing Naphthopyran may be applied to the front or first surface of an EC mirror reflective element to provide a change in color under highlight from UV (see FIGS. 2 and 3). For example, in FIG. 2, the mirror reflective element is not exposed to sunlight or UV light and the coating 30 is transparent, while in FIG. 3, the mirror reflective element is exposed to UV light and the coating 30 is colored or tinted or darkened, which reduces the reflection of light incident at the mirror reflective element.

The TFC is applied to the first surface and will change color whenever UV light is incident at it (i.e., upon photo-irradiation with UV light). The color change for Naphthopyran is from colorless to yellow, however, with further functional group additions, the colors can be tuned to the customer's desire, depending on the particular application and desired appearance of the film when colored.

The application of the photochromic TFC improves upon the current EC mirror reflective element by adding a second color changing function to the mirror reflective element to improve the driver's experience while driving. EC functionality at night helps reduce glare (such as responsive to a glare sensor that senses glare light from headlights of trailing vehicles) and visibility issues that arise from the glare caused by the headlights of following vehicles. Photochromic functionality during the day helps reduce glare and visibility issues from the sun (and since the photochromic layer is transparent in nighttime driving conditions, it has little or no effect on the performance of the EC mirror at night).

The photochromic coating is a passive element and does not require any electrical power to darken or dim or color. The intensity of the UV irradiation of which the coating is exposed controls the transformation and reversion.

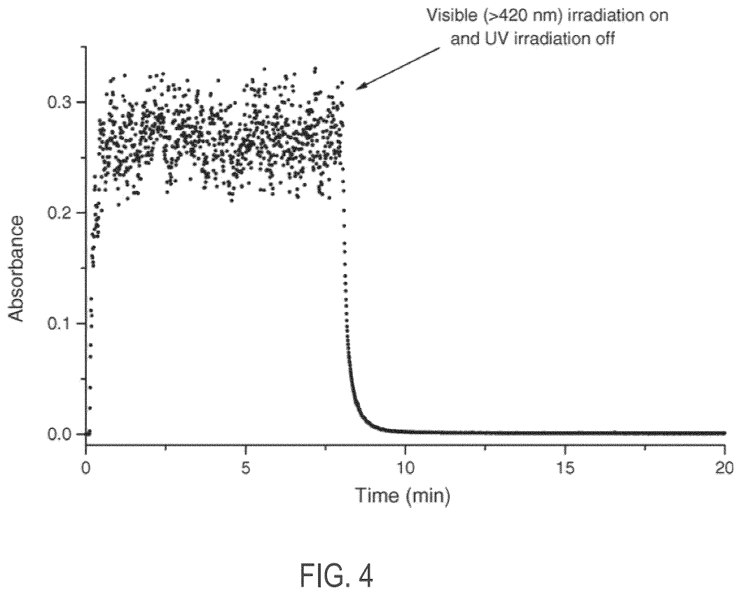

Varying the functional groups on positions R1, R2, etc. cause the color change to be noticeable. These functional groups will also make a shift in time-to-color and time-to-reversion. Naphthopyran is not soluble in the average polymer system, but with soluble functional group additions, it can even become polar and dissolve in water. The use of indeno-fused Naphthopyrans has resulted in decreased coloring time. Time to color occurs in less than 10 seconds and time to reversion occurs in less than 40 seconds (see FIG. 4). Indeno-fused Naphthopyrans cause transition lenses to work quickly.

In one example, the absorptive wavelength may be around 440 nm, the color may be orange/yellow, and the solution may be non-soluble:

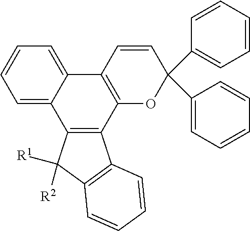

In another example, the absorptive wavelength may be around 618 nm, the color may be blue, and the solubility may be epoxy resin:

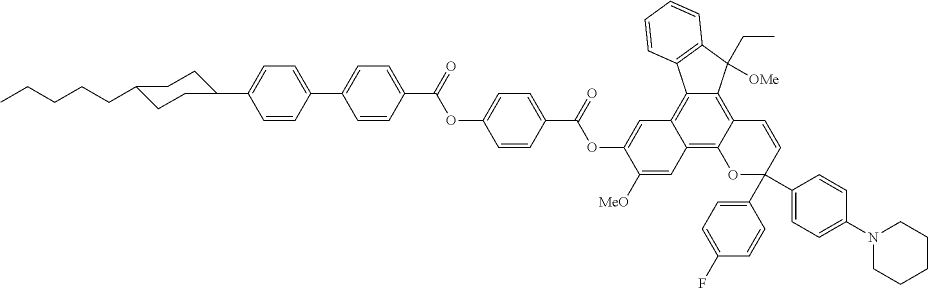 [SMILES: CCCCCC1CCC(c2ccc(-c3ccc(C(=O)Oc4ccc(C(=O)Oc5cc6c7c(c8c(c6cc5OC)OC(c5ccc(F)cc5)(c5ccc(N6CCCCC6)cc5)C=C8)C(CC)(OC)c5ccccc5-7)cc4)cc3)cc2)CC1]

In another example, the absorptive wavelength may be around 644 nm, the color may be green, and the solubility may be epoxy resin:

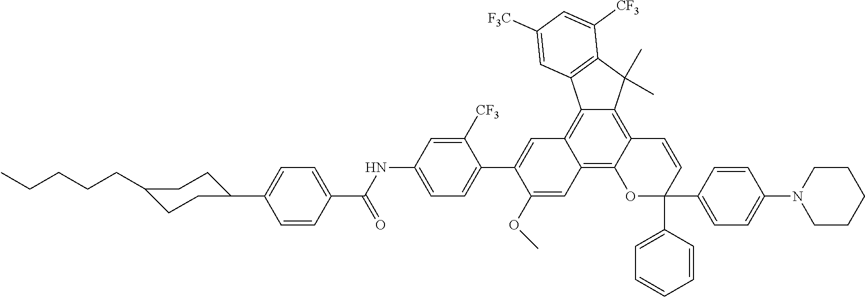 [SMILES: CCCCCC1CCC(c2ccc(C(=O)Nc3ccc(-c4cc5c6c(c7c(c5cc4OC)OC(c4ccccc4)(c4ccc(N5CCCCC5)cc4)C=C7)C(C)(C)c4c-6cc(C(F)(F)F)cc4C(F)(F)F)c(C(F)(F)F)c3)cc2)CC1]

Many different colors may be provided for the photochromic film or layer or coating. The coating will be transparent when not colored, and will color to the selected color when exposed to sunlight.

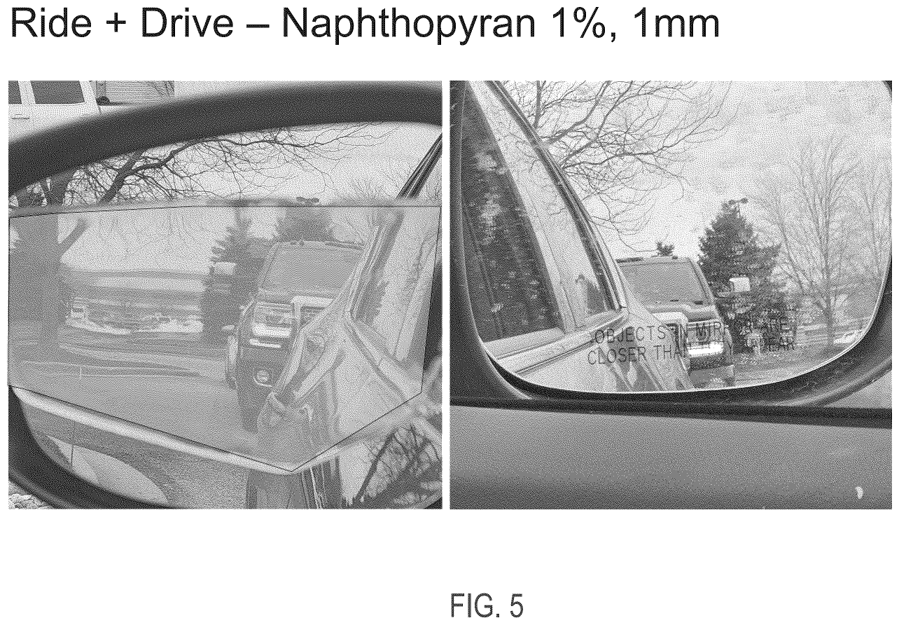

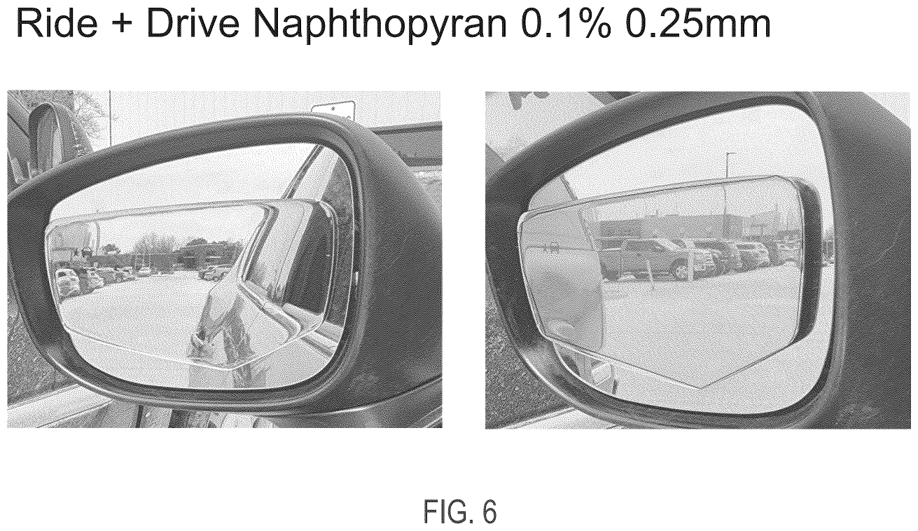

Naphthopyran may be used in an epoxy system (such as similar to the epoxy system used for the perimeter seal of the EC cell, and may be used in, for example, 0.01% concentration (see FIG. 6, showing performance of a 0.25 mm thick film having a 0.1% concentration)) with 0.25% concentration and 1% concentration (see FIG. 5, showing performance of a 1 mm thick film having a 1% concentration). The Naphthopyran may be dissolved in a hexane solution or an IPA (isopropyl alcohol) solution. In testing, a high powered UV light may be used to determine time to darken or color when exposed to UV light and time to return to the transparent state after exposure.

The perimeter seal epoxy system is difficult to work with and provides distortion for an active coating. The solution was tested with a different epoxy system with Naphthopyran dispersed, which provided less than 10 seconds for dim time, less than 25 seconds for reversion, drastically decreased depth of color, and decreased reversion time due to UV-protecting curing system.

Thus, the mirror reflective element may have a thin film coating of a photochromic material to provide coloring of the mirror reflective element during daytime exposure of sunlight (which would not cause coloring of an electrochromic medium of the mirror reflective element). The thin film coating is applied to the first or front or exposed outermost side or surface of the mirror reflective element and colors or darkens from a transparent state toward a colored state when exposed to UV light, such as during high ambient light conditions. The thin film coating of photochromic material may be applied to the front or first side of the front glass substrate of an electro-optic (e.g., electrochromic) mirror reflective element, or may be applied to the front or first side of a single glass element of a non-electro-optic mirror reflective element (such as often implemented at a passenger side of a vehicle and sometimes at the driver side of the vehicle as well). The coating of photochromic material provides for mirror dimming or coloring during daytime driving conditions to reduce sun glare while not affecting electrochromic performance during nighttime driving conditions.

The mirror assembly may utilize aspects of the mirror assemblies described in U.S. Publication Nos. US-2021-0331625; US-2021-0316664; US-2021-0213880; US-2020-0353867 and/or US-2020-0223364, and/or U.S. Pat. Nos. 11,325,535; 10,099,618; 9,827,913; 9,487,142; 9,346,403 and/or 8,915,601, which are all hereby incorporated herein by reference in their entireties.

Optionally, the exterior mirror element of a mirror assembly may include heater pad or film or element at a rear surface of the mirror reflective element. The heater pad or element at the rear surface of the glass substrate may comprise a mirror defrost/demisting heater and may provide an anti-fogging or de-fogging feature to the exterior mirror assembly, and may utilize aspects of the heater elements or pads described in U.S. Pat. Nos. 9,481,304; 8,058,977; 7,400,435; 5,808,777; 5,610,756 and/or 5,446,576, and/or U.S. Pat. Publication No. US-2008-0011733; which are hereby incorporated herein by reference in their entireties. The heater element may include electrical contacts that extend rearward therefrom and through an aperture of attaching portion of back plate for electrical connection to a wire harness or connector of the mirror assembly, or the back plate and/or heater pad may include suitable electrical connectors and connections incorporated therein (such as by utilizing aspects of the mirror assembly described in U.S. Pat. No. 7,400,435, which is hereby incorporated herein by reference in its entirety) for electrically connecting the heater pad (or other suitable electrical connectors may be utilized, such as electrical leads or wire harnesses or pigtails or other separate connectors or cables or the like). Optionally, the heater pad may comprise a screen printed heater pad. For example, the heater pad may be printed on the back of the mirror reflective element (such as at the fourth or rear surface of the rear substrate). Such coatings may be printed and then cured at around 120 degrees C. or lower, making this process compatible with already formed laminate type EC mirror elements, such as those described in U.S. Pat. No. 5,724,187, which is hereby incorporated herein by reference in its entirety. This would make the coating and process compatible with EC mirrors.

The mirror casing may include a bezel portion that circumscribes a perimeter region of the front surface of the reflective element, or the perimeter region of the front surface of the reflective element may be exposed (such as by utilizing aspects of the mirror reflective elements described in U.S. Pat. Nos. 8,508,831 and/or 8,730,553, and/or U.S. Publication Nos. US-2014-0022390; US-2014-0293169 and/or US-2015-0097955, which are hereby incorporated herein by reference in their entireties).

As discussed above, the mirror assembly may comprise an electro-optic or electrochromic mirror assembly that includes an electro-optic or electrochromic reflective element. The perimeter edges of the reflective element may be encased or encompassed by the perimeter element or portion of the bezel portion to conceal and contain and envelop the perimeter edges of the substrates and the perimeter seal disposed therebetween. The electrochromic mirror element of the electrochromic mirror assembly may utilize the principles disclosed in commonly assigned U.S. Pat. Nos. 7,274,501; 7,255,451; 7,195,381; 7,184,190; 6,690,268; 5,140,455; 5,151,816; 6,178,034; 6,154,306; 6,002,544; 5,567,360; 5,525,264; 5,610,756; 5,406,414; 5,253,109; 5,076,673; 5,073,012; 5,117,346; 5,724,187; 5,668,663; 5,910,854; 5,142,407 and/or 4,712,879, which are hereby incorporated herein by reference in their entireties.

Optionally, image data captured by a rearward-viewing camera (e.g., a rear backup camera or other rearward-viewing camera disposed at a rear portion of the vehicle, or a driver or occupant or cabin monitoring camera that views rearward within the cabin of the vehicle and rearward of the vehicle via a rear window of the vehicle) may be image processed to determine ambient light (and/or glare light) present at the vehicle. Thus, for example, during nighttime driving, image processing of captured image data can be used to appropriately control dimming of the mirror reflective element or the intensity of backlighting of a video display screen to be appropriate for nighttime driving. Also, for example, during high ambient driving, the backlighting is increased so the displayed images are not washed out. The intelligent/automatic mirror dimming functions and/or video display screen dimming functions may utilize aspects of the systems described in U.S. Pat. Nos. 11,780,372; 11,242,008; 10,967,796 and/or 10,948,798, and/or U.S. Publication No. US-2024-0064274, which are all hereby incorporated herein by reference in their entireties.

Optionally, the reflective element may include an opaque or substantially opaque or hiding perimeter layer or coating or band disposed around a perimeter edge region of the front substrate (such as at a perimeter region of the rear or second surface of the front substrate) to conceal or hide or the perimeter seal from viewing by the driver of the vehicle when the mirror assembly is normally mounted in the vehicle. Such a hiding layer or perimeter band may be reflective or not reflective and may utilize aspects of the perimeter bands and mirror assemblies described in U.S. Pat. Nos. 5,066,112; 7,626,749; 7,274,501; 7,184,190; 7,255,451; 8,508,831 and/or 8,730,553, which are all hereby incorporated herein by reference in their entireties. Optionally, the perimeter band may comprise a chrome/chromium coating or metallic coating and/or may comprise a chrome/chromium or metallic coating that has a reduced reflectance, such as by using an oxidized chrome coating or chromium oxide coating or “black chrome” coating or the like (such as by utilizing aspects of the mirror assemblies described in U.S. Pat. Nos. 7,184,190 and/or 7,255,451, which are hereby incorporated herein by reference in their entireties). Optionally, other opaque or substantially opaque coatings or bands may be implemented.

Although described as being a mirror reflective element for an exterior rearview mirror assembly, it is envisioned that aspects of the photochromic thin film coating may be used on an interior mirror reflective element. Also, although described as being a mirror reflective element, the photochromic film or layer may be used at an automotive window or glazing to tint the window responsive to sunlight or bright lighting conditions. For example, an exterior side or surface of a windshield or side window or rear window or sunroof of a vehicle may be coated with the photochromic layer or coating, so that the window may darken or tint or color when exposed to sunlight. Optionally, the photochromic film or layer may be used at a display screen to tint or darken the display during bright lighting conditions. For example, an outer surface of the video display screen may be coated with the photochromic layer or coating, so that the display screen may darken or tint or color when exposed to sunlight.

Changes and modifications in the specifically described embodiments may be carried out without departing from the principles of the present invention, which is intended to be limited only by the scope of the appended claims as interpreted according to the principles of patent law.

1. A vehicular mirror reflective element, the vehicular mirror reflective element comprising:
at least one glass substrate;
wherein the at least one glass substrate has a first side that is closest to and viewed by a driver of a vehicle equipped with a vehicular rearview mirror assembly that includes the vehicular mirror reflective element;
a mirror reflector disposed at another side of the at least one glass substrate that is different than the first side; and
a photochromic layer disposed at the first side of the at least one glass substrate of the vehicular mirror reflective element.

2. The vehicular mirror reflective element of claim 1, wherein the vehicular mirror reflective element comprises an electrochromic mirror reflective element, and wherein the at least one glass substrate comprises a front glass substrate and a rear glass substrate and an electrochromic medium sandwiched between the front glass substrate and the rear glass substrate, and wherein the front glass substrate comprises the first side, and wherein the rear glass substrate comprises the side at which the mirror reflector is disposed.

3. The vehicular mirror reflective element of claim 2, wherein the side at which the mirror reflector is disposed comprises the side of the rear glass substrate that faces the electrochromic medium and the front glass substrate.

4. The vehicular mirror reflective element of claim 2, wherein the side at which the mirror reflector is disposed comprises the side of the rear glass substrate that faces away from the electrochromic medium and the front glass substrate.

5. The vehicular mirror reflective element of claim 1, wherein the at least one glass substrate comprises a single glass substrate, and wherein the side at which the mirror reflector is disposed comprises a second side of the single glass substrate that is opposite the first side.

6. The vehicular mirror reflective element of claim 1, wherein the photochromic layer comprises a Naphthopyran solution.

7. The vehicular mirror reflective element of claim 6, wherein the photochromic layer comprises an epoxy solution.

8. The vehicular mirror reflective element of claim 1, wherein the photochromic layer is transparent when not exposed to sunlight.

9. The vehicular mirror reflective element of claim 1, wherein the vehicular rearview mirror assembly comprises an exterior rearview mirror assembly configured for mounting at a side of the vehicle.

10. A vehicular mirror reflective element, the vehicular mirror reflective element comprising:
a glass substrate;
wherein the glass substrate has a first side and a second side opposite the first side and separated from the first side by a thickness dimension of the glass substrate, and wherein the first side of the glass substrate is closest to and viewed by a driver of a vehicle equipped with a vehicular rearview mirror assembly that includes the vehicular mirror reflective element;
a mirror reflector disposed at the second side of the glass substrate of the vehicular mirror reflective element; and
a photochromic layer disposed at the first side of the glass substrate of the vehicular mirror reflective element.

11. The vehicular mirror reflective element of claim 10, wherein the photochromic layer comprises a Naphthopyran solution.

12. The vehicular mirror reflective element of claim 11, wherein the photochromic layer comprises an epoxy solution.

13. The vehicular mirror reflective element of claim 10, wherein the photochromic layer is transparent when not exposed to sunlight.

14. The vehicular mirror reflective element of claim 10, wherein the vehicular rearview mirror assembly comprises an exterior rearview mirror assembly configured for mounting at a side of the vehicle.

15. A vehicular mirror reflective element, the vehicular mirror reflective element comprising:
a front glass substrate and a rear glass substrate and an electrochromic medium sandwiched between the front glass substrate and the rear glass substrate,
wherein the front glass substrate comprises a first side and a second side opposite the first side and separated from the first side by a thickness dimension of the front glass substrate;
wherein the rear glass substrate comprises a third side and a fourth side separated from the third side by a thickness dimension of the rear glass substrate;
wherein the first side of the front glass substrate is closest to and viewed by a driver of a vehicle equipped with a vehicular rearview mirror assembly that includes the vehicular mirror reflective element;
wherein the second side of the front glass substrate faces the electrochromic medium and the third side of the rear glass substrate faces the electrochromic medium;
a mirror reflector disposed at the rear glass substrate of the vehicular mirror reflective element; and
a photochromic layer disposed at the first side of the front glass substrate of the vehicular mirror reflective element.

16. The vehicular mirror reflective element of claim 15, wherein the mirror reflector is disposed at the third side of the rear glass substrate.

17. The vehicular mirror reflective element of claim 15, wherein the mirror reflector is disposed at the fourth side of the rear glass substrate.

18. The vehicular mirror reflective element of claim 15, wherein the photochromic layer comprises a Naphthopyran solution.

19. The vehicular mirror reflective element of claim 18, wherein the photochromic layer comprises an epoxy solution.

20. The vehicular mirror reflective element of claim 15, wherein the photochromic layer is transparent when not exposed to sunlight.

21. The vehicular mirror reflective element of claim 15, wherein the vehicular rearview mirror assembly comprises an exterior rearview mirror assembly configured for mounting at a side of the vehicle.
